(19) United States
(12) Patent Application Publication
(10) Pub. No.: US 2023/0015668 A1
(43) Pub. Date: Jan. 19, 2023

(54) CMP POLISHING PAD

(71) Applicant: Rohm and Haas Electronic Materials CMP Holdings, Inc., Newark, DE (US)

(72) Inventors: Bainian Qian, Newark, DE (US); Donna M. Alden, Bear, DE (US); Matthew Cimoch, Newark, DE (US); Nan-Rong Chiou, Wilmington, DE (US); Sheng-Huan Tseng, Zhubei (TW)

(21) Appl. No.: 17/365,046

(22) Filed: Jul. 1, 2021

(51) Int. Cl. B24B 37/24; B24B 37/22

(52) U.S. Cl. CPC B24B 37/24; B24B 37/22

(57) ABSTRACT

A polishing pad has a polishing layer comprising a polymer matrix comprising the reaction product of an isocyanate terminated urethane prepolymer and a chlorine-free aromatic polyamine cure agent and chlorine-free microelements. The microelements can be expanded, hollow microelements. The microelements can have a specific gravity measured of 0.01 to 0.2. The microelements can have a volume averaged particle size of 1 to 120 or 15 to 30 micrometers. The polishing layer is chlorine free.

### FIELD OF THE INVENTION

The present invention relates generally to polishing pads for chemical mechanical polishing of substrates, including particularly polishing of silicon oxide containing substrates in the manufacture of microelectronics.

### BACKGROUND

In the fabrication of integrated circuits and other electronic devices, multiple layers of conducting, semiconducting and dielectric materials are deposited onto and partially or selectively removed from a surface of a semiconductor wafer. Thin layers of conducting, semiconducting and dielectric materials may be deposited using a number of deposition techniques. In addition, in damascene processes a material is deposited to fill recessed areas created by patterned etching of trenches and vias. As the filling is conformal this can lead to irregular surface topography. Also, to avoid underfilling extra material can be deposited. Thus, material outside the recesses needs to be removed. Common deposition techniques in modern wafer processing include physical vapor deposition (PVD), also known as sputtering, chemical vapor deposition (CVD), plasma-enhanced chemical vapor deposition (PECVD) and electrochemical deposition (ECD), among others. Common removal techniques include wet and dry etching; isotropic and anisotropic etching, among others.

As materials are sequentially deposited and removed, the topography of the substrate can become non-uniform or non-planar. Because subsequent semiconductor processing (e.g., photolithography, metallization, etc.) requires the wafer to have a flat surface, the wafer needs to be planarized. Planarization is useful for removing undesired surface topography and surface defects, such as rough surfaces, agglomerated materials, crystal lattice damage, scratches and contaminated layers or materials.

Chemical mechanical planarization, also referred to as chemical mechanical polishing (CMP), is a common technique used to planarize or polish workpieces such as semiconductor wafers and to remove excess material in damascene processes, front end of line (FEOL) processes or back end of line (BEOL) processes. In conventional CMP, a wafer carrier, or polishing head, is mounted on a carrier assembly. The polishing head holds the wafer and positions the wafer in contact with a polishing surface of a polishing pad that is mounted on a table or platen within a CMP apparatus. The carrier assembly provides a controllable pressure between the wafer and polishing pad. Simultaneously, a slurry or other polishing medium is dispensed onto the polishing pad and is drawn into the gap between the wafer and polishing layer. To effect polishing, the polishing pad and wafer typically rotate relative to one another. As the polishing pad rotates beneath the wafer, the wafer traverses a typically annular polishing track, or polishing region, wherein the wafer's surface directly confronts the polishing layer. The wafer surface is polished and made planar by chemical and mechanical action of the polishing surface and polishing medium (e.g., slurry) on the surface.

### SUMMARY OF THE INVENTION

Disclosed herein is a polishing pad useful in chemical mechanical polishing having a polishing layer comprising a polymer matrix comprising the reaction product of an isocyanate terminated urethane prepolymer and a chlorine-free aromatic polyamine cure agent and chlorine-free microelements distributed within the polymer matrix. The microelements can be hollow microelements (e.g. expanded microelements). The microelements can have a specific gravity of 0.01 to 0.2. The microelements can have a volume averaged particle size of 1 to 120 or 15 to 30 micrometers. The hollow microelements can have an average wall thickness of 30 to 300 nanometers. The polishing layer is chlorine free.

### DETAILED DESCRIPTION OF THE INVENTION

The polishing pad disclosed here comprises a polymer matrix comprising the reaction product of an isocyanate terminated urethane prepolymer and a chlorine-free aromatic polyamine cure agent and chlorine-free microelements.

“Chlorine-free” as it relates to a compound (e.g. the cure agent) means that the compound(s) used as the cure agent do not include chlorine atoms in the chemical formula.
“Chlorine-free” as it relates to a composition, article or component means chlorine is not detectable in the composition. Preferably, the overall polishing layer means the component (e.g. microelements or polishing layer) has a chlorine content less than 0.1 wt % based on total weight of the polishing layer as determined by energy-dispersive X-ray spectroscopy (EDS) or by Combustion Ion Chromatography (CIC) as set out in ASTM D7359-18. Most preferably, the overall polishing layer means the component (e.g. microelements or polishing layer) has a chlorine content less than 0.01 wt % based on total weight of the polishing layer as determined by Combustion Ion Chromatography (CIC) as set out in ASTM D7359-18. CIC represents a more accurate method of measuring chlorine concentration.

“Volume averaged particle size” means D50 or D(v, 0.5) particle size. It is the value of the particle diameter at 50% in the cumulative distribution. For example, if D50=15 micrometers, then 50% of the particles in the sample are larger than 15 micrometers, and 50% smaller than 15 micrometers. The particle size and distribution can be determined by laser diffraction (e.g. using a Mastersizer™ instrument from Malvern).

The polishing pads disclosed herein yield surprisingly improved removal rate (for example of silicon oxide containing substrates, particularly those based on tetraorthoethylsilicate (TEOS)) as compared to a similar pad having a chlorine containing microelement and/or having a polymer matrix formed from a chlorine containing cure agent. In addition, the pad has the benefit of being chlorine free.

The polishing layer comprises a polymer matrix which is chlorine free. The polymer matrix can be the reaction of an isocyanate terminated urethane with a chlorine free cure agent.

The isocyanate-terminated urethane prepolymer can have 2 to 15 wt %, 5 to 13 wt %, 6-12 wt %, 7 to 11 wt %, or 8 to 10 wt % unreacted isocyanate (NCO) groups. The prepolymer can be formed by reaction of a polyisocyanate, (e.g. a diisocyanate) and a polyol. Examples of suitable polyisocyanates include 2,4-toluene diisocyanate; 2,6-toluene diisocyanate; 4,4′-diphenylmethane diisocyanate; naphthalene-1,5-diisocyanate; tolidine diisocyanate; para-phenylene diisocyanate; xylylene diisocyanate; isophorone diisocyanate; hexamethylene diisocyanate; 4,4′-dicyclohexylmethane diisocyanate; cyclohexanediisocyanate; and, mixtures thereof. The polyol used to form the polyfunctional isocyanate terminated urethane prepolymer can be selected from the group consisting of diols, polyols, polyol diols, copolymers thereof and mixtures thereof. For example, the prepolymer polyol can be selected from the group consisting of polyether polyols (e.g., poly(oxytetramethylene)glycol, poly(oxypropylene)glycol and mixtures thereof); polycarbonate polyols; polyester polyols; polycaprolactone polyols; mixtures thereof and, mixtures thereof with one or more low molecular weight polyols selected from the group consisting of ethylene glycol; 1,2-propylene glycol; 1,3-propylene glycol; 1,2-butanediol; 1,3-butanediol; 2-methyl-1,3-propanediol; 1,4-butanediol; neopentyl glycol; 1,5-pentanediol; 3-methyl-1,5-pentanediol; 1,6-hexanediol; diethylene glycol; dipropylene glycol; and, tripropylene glycol. The polyisocyanate and the polyol can be chlorine free.

The cure agent can be a chlorine free aromatic diamine. For example, the cure agent can have the formula

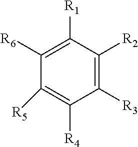

where R₁ and R₃ or R₁ and R₄ are amine groups (i.e. —NH₂) or alkyl amine groups having 1 to 5 carbon atoms, preferably amine groups, and R₂, R₅, R₆, and whichever of R₃ or R₄ is not an amine containing group are independently selected in each occurrence from H, -L-alkyl groups of 1-4, preferably 1-2, carbon atoms, where L is a direct bond, or a linking group, preferably O or S, most preferably S.

Examples of cure agents include diethyl toluene diamine (DETDA), dimethyl thio-toluene diamine (DMTDA), or a combination thereof.

The amount of cure agent used relative to prepolymer can be 5 to 40 wt % based on total weight of the prepolymer and cure agent. The amount of cure agent can vary depending on available functional groups in the cure agent and in prepolymer. Cure can occur at an elevated temperature. For example, cure can occur at a temperature of at least 50, or at least 80 or at least 100° C. and up to 150° C. or up to 120° C. Where a hollow, polymeric microelement is used, the cure temperature is preferably below the glass transition temperature of the polymer of the wall of the microelement. Cure can occur over a period of time, for example 1 to 20 hours, or 5 to 18 hours or 10 to 16 hours to make a bulk cured polishing layer material.

The prepolymer and cure agent can be mixed with the microelements and then cured.

The microelements can be hollow microelements or hollow microspheres. The microelements can be expanded polymeric microspheres. The microelements can have a specific gravity of 0.01 to 0.2, 0.02-0.15, 0.05 to 0.1, or 0.070 to 0.096. The specific gravity can be determined for example by gas pycnometry before distributing the microelements in the polymer matrix. A pycnometer has two chambers, one cell chamber and the one expansion chamber, with known volumes. A pre-weighed sample can be placed in the cell chamber, the valve to the expansion chamber is closed and the pressure in the cell chamber is set by air at about 5 psi. When the pressure in the cell chamber is equilibrated, the valve to the expansion chamber is opened and a new equilibrium pressure is reached in both the cell and the expansion chamber. Pycnometer volume of the sample can then be calculated using the gas law under these two different conditions. The density is then the weight divided by the volume, while the specific gravity is the density divided by the density of water at 4° C.

The microelements can have a volume averaged particle size of 1 to 120, 5-80, 15-40, or 15-30 micrometers as determined by laser diffraction. The hollow microelements can have a wall thickness of 30 to 300 nanometers, or 50 to 200 nanometers. Wall thickness can be determined, for example, by scanning electron microscopy of a cross-section of hollow microelements in a polymer matrix. The polymeric microelements can comprise a shell comprising an acrylonitrile copolymer, with a commoner. The comonomer can be another ethylenically unsaturated monomer such as acrylates (e.g. butyl acrylate), methacrylates (e.g. methyl methacrylate, ethyl methacrylate), acrylic acids, methacrylic acids, vinyl aromatic monomers (e.g. styrene, divinyl benzine), vinyl acetate, or substituted acrylonitrile (e.g. methacrylonitrile)

The amount of microelements distributed within the polymer matrix in the polishing layer can be of 5 to 50, 10 to 45, 10 to 40, or 10 to 35 percent by volume based on total volume of the polishing layer.

The microelements can be mixed with the pre-polymer and cure agent prior to cure.

The polishing layer can have a density of 0.4 to 1.15, or 0.7 to 1.0 g/cm³ as measured according to ASTM D1622 (2014).

The polishing layer can have a Shore D hardness of 28 to 75 as measured according to ASTM D2240 (2015).

The polishing layer can have an average thickness of 20 to 150 mils, 30 to 125 mils, 40 to 120 mils, or 50 to 100 mils (0.5-4, 0.7-3, 1-3, or 1.3-2.5 mm).

The polishing layer is chlorine free. The entire polishing pad can be chlorine free.

The polishing pad of the present invention optionally further comprises at least one additional layer interfaced with the polishing layer. For example, the polishing pad can further comprise a compressible base layer adhered to the polishing layer. The compressible base layer can improve conformance of the polishing layer to the surface of the substrate being polished. The base pad (also referred to as sublayer or base layer) can be used under the polishing portion. The base pad can be a single layer or can comprise more than one layer. For example, the polishing layer may be attached to a base pad via mechanical fasteners or by an adhesive. The base layer can have a thickness of at least 0.5 or at least 1 mm. The base layer can have a thickness of no more than 5, no more than 3, or no more than 2 mm.

The base pad or base layer may comprise any material known for use as base layers for polishing pads. For example, it can comprise a polymer, a blend of polymers or a composite of a polymeric material with other materials, such as ceramic, glass, metal, or stone. Polymers and polymer composites can be used as the base pad, particularly for the top layer if there is more than one layer, due to compatibility with the material which can form the polishing portion. Examples of such composites include polymers filled with carbon or inorganic fillers and fibrous mats of, for example glass or carbon fibers, impregnated with a polymer. The base of the pad can be made of a material having one or more of the following properties: a Young's modulus as determined, for example, by ASTM D412-16 in the range of at least 2, at least 2.5, at least 5, at least 10, or at least 50 MPa up to 900, up to 700, up to 600, up to 500, up to 400, up to 300, or up to 200 MPa; a Poisson's ratio as determined, for example, by ASTM E132 of at least 0.05, at least 0.08, or at least 0.1 up to 0.6 or up to 0.5; a density of at least 0.4 or at least 0.5 up to 1.7, up to 1.5, or up to 1.3 grams per cubic centimeter (g/cm³).

Examples of such polymeric materials that can be used in the base pad or polishing portion include polycarbonates, polysulfones, nylons, epoxy resins, polyethers, polyesters, polystyrenes, acrylic polymers, polymethyl methacrylates, polyvinylchlorides, polyvinyl fluorides, polyethylenes, polypropylenes, polybutadienes, polyethylene imines, polyurethanes, polyether sulfones, polyamides, polyether imides, polyketones, epoxies, silicones, copolymers thereof (such as, polyether-polyester copolymers), or combinations or blends thereof. The polymer can be a polyurethane. The polyurethane can be used alone or can be a matrix for carbon or inorganic fillers and fibrous mats of, for example glass or carbon fibers,

The polishing pad of the present invention in its final form further can include the incorporation of texture of one or more dimensions on its upper surface. These may be classified by their size into macrotexture or microtexture. Common types of macrotexture employed for CMP to control hydrodynamic response and/or slurry transport, include, without limitation, grooves of many configurations and designs, such as annular, radial, and cross-hatchings. These may be formed via machining processes to a thin uniform sheet or may be directly formed on the pad surface via a net shape molding process. Common types of microtexture are finer scale features which create a population of surface asperities which are the points of contact with the substrate wafer where polishing occurs. Common types of microtexture include, without limitation, texture formed by abrasion with an array of hard particles, such as diamond (often referred to as pad conditioning), either prior to, during or after use, and microtexture formed during the pad fabrication process.

The polishing pad of the present invention can be suitable to be interfaced with a platen of a chemical mechanical polishing machine. The polishing pad can be affixed to the platen of a polishing machine. The polishing pad can be affixed to the platen using at least one of a pressure sensitive adhesive and vacuum.

The polishing pads of the present invention may be manufactured by a variety of processes that are compatible with the properties of the pad polymer being used. These include mixing the ingredients as described above and casting into a mold, annealed, and sliced into sheets of the desired thickness. Alternatively, they may be made in a more precise net shape form. Processes for manufacture include: 1. thermoset injection molding (often referred to as “reaction injection molding” or “RIM′), 2. thermoplastic or thermoset injection blow molding, 3.compression molding, or 4. any similar-type process in which a flowable material is positioned and solidified, thereby creating at least a portion of a pad's macrotexture or microtexture. In an example of molding the polishing pad: 1. the flowable material is forced into or onto a structure or substrate; 2. the structure or substrate can impart a surface texture into the material as it solidifies, and 3. the structure or substrate is thereafter separated from the solidified material.

The pad disclosed here can be used in a method for polishing. For example the method can include: providing a chemical mechanical polishing apparatus having a platen or carrier assembly; providing at least one substrate to be polished; providing a chemical mechanical polishing pad as disclosed herein; installing onto the platen the chemical mechanical polishing pad; optionally, providing a polishing medium (e.g. abrasive containing slurry and/or non-abrasive containing reactive liquid composition) at an interface between a polishing portion of the chemical mechanical polishing pad and the substrate; creating dynamic contact between the polishing portion of the polishing pad and the substrate, wherein at least some material is removed from the substrate. The carrier assembly can provide a controllable pressure between the substrate being polished (e.g. wafer) and the polishing pad. A polishing medium can be dispensed onto the polishing pad and drawn into the gap between the wafer and polishing layer. The polishing medium can comprise water, a pH adjusting agent, and optionally one or more of, but not limited to, the following: abrasive particles, an oxidizing agent, an inhibitor, a biocide, soluble polymers, and salts. The abrasive particle can be an oxide, metal, ceramic, or other suitably hard material. Typical abrasive particles are colloidal silica, fumed silica, ceria, and alumina. The polishing pad and substrate can rotate relative to one another. As the polishing pad rotates beneath the substrate, the substrate can sweep out a typically annular polishing track, or polishing region, wherein the wafer's surface directly confronts the polishing portion of the polishing pad. The wafer surface is polished and made planar by chemical and mechanical action of the polishing layer and polishing medium on the surface. Optionally, the polishing surface of the polishing pad can be conditioned with an abrasive conditioner before beginning polishing.

Optionally, the pad can include a window for end-point detection. In that instance, the method of the present invention, the chemical mechanical polishing apparatus provided can further include a signal source (e.g. a light source) and a signal detector (e.g. a photosensor (preferably, a multi-sensor spectrograph). In that instance, the method can further comprise: determining a polishing endpoint by transmitting a signal (e.g. light from the light source) through the window and analyzing the signal (e.g. light) reflected off the surface of the substrate back through the endpoint detection window incident upon the sensor (e.g. photosensor). The substrate can have a metal or metallized surface, such as one containing copper or tungsten. The substrate can be a magnetic substrate, an optical substrate and a semiconductor substrate.

### Examples

### Pad Production

Cast polyurethane cakes are prepared by the controlled mixing of (a) a commercially available isocyanate terminated prepolymer (which can be pre-heated, for example, to 51° C. and which is the reaction product of toluene diisocyanate, TDI and a polyether based polyol; (b) a cure agent and, (c) polymer microspheres. When the cure agent is 4,4′-methylenebis(2-chlororaniline) (MbOCA) it can be pre-heated to 116° C. When the cure agent is dimethyl thio-toluene diamine (DMTDA) it can be pre-heated to 46° C. After exiting the mix head, the combination is dispensed over a period of 3 minutes into an 86.4 cm (34 inch) diameter circular mold to give a total pour thickness of approximately 8 cm (3 inches). The dispensed combination is allowed to gel for 15 minutes before placing the mold in a curing oven. The mold is then cured in the curing oven using the following cycle: 30 minutes ramp of the oven set point temperature from ambient temperature to 104° C., and then hold for 15.5 hours with an oven set point temperature of 104° C.

The loading of the polymer microspheres is controlled to target similar polishing layer density of 0.8 g/cm³, or at 32 percent by volume based on total volume of the polishing layer portion. The components for the polishing layer are as set forth in the following table.

| | | | Polymer microspheres | | | |
|---|---|---|---|---|---|---|
| | | | | Average | | |
| | Prepolymer | | Chlorine | particle size, | Specific | Chlorine content |
| | NCO, wt % | Curative | presence | micrometers | gravity (SG) | by EDS |
| Ex. 1 | 8.95 to 9.25 | DMTDA | No | 17 to 27 | 0.070 to 0.096 | Not detected* |
| | | | | | | (<0.1 wt %) |
| Ex. 2 | 7.96 to 8.41 | DMTDA | No | 17 to 27 | 0.070 to 0.096 | Not detected* |
| | | | | | | (<0.1 wt %) |
| Comp. | 8.95 to 9.25 | DMTDA | Yes | 15 to 25 | 0.064 to 0.076 | 1.7 wt % |
| Ex. 1 | | | | | | |
| Comp. | 8.95 to 9.25 | MbOCA | No | 17 to 27 | 0.070 to 0.096 | 2.7 wt % |
| Ex. 2 | | | | | | |

*<0.01 wt % combustion ion chromatography (ASTM D7359-18)

The polishing layer is about 2 mm thick and is machined to provide grooves. The polishing layer is attached to a foamed sub-pad using a reactive hot melt adhesive.

### Pad Testing

The pads are tested using a ceria abrasive based slurry with additive package, premixed at 60 abrasive parts and 240 additive parts. After conditioning the pad, the polishing is done on at a down force of 3.3 psi (0.023 MPa) at 145 rotations per minute for the platen and 133 rotations per minute for the head and a polishing time of 60 seconds. Dummy and TEOS derived silicon oxide monitor wafers are run.

For a first test, pads according to Examples 1 and 2 were compared to Comparative Example 1 with the results as shown in the following table. Pads having the chlorine free microspheres showed surprisingly better TEOS derived silicon oxide removal than did the pads having chlorine containing microspheres.

| | Average | |
|---|---|---|
| | removal rate, | Normalized |
| | Å/min | removal rate |
| Ex. 1 | 4069 | 139% |
| Ex. 2 | 3653 | 124% |
| Comp. Ex. 1 | 2935 | 100% |

For a second test, pads according to Example 1 having a chlorine free curative —dimethyl thio-toluene diamine—were compared to pads where 4,4′-methylenebis(2-chloroaniline) (MBOCA) was instead used as the curative. Surprisingly, polishing results showed that Ex. 1 delivered improved TEOS removal rate over Comp. Ex. 2 (with chlorine-free polymer microspheres but chlorine-containing curative), with 42% removal rate improvement and 26% defect reduction.

| | Average | | Defect counts | |
|---|---|---|---|---|
| | removal rate, | Normalized | (scratches and | Normalized |
| | Å/min | removal rate | chattermarks) | defect counts |
| Ex. 1 | 3338 | 142% | 14 | 74% |
| Comp. Ex. 2 | 2344 | 100% | 19 | 100% |

This disclosure further encompasses the following aspects:

Aspect 1: A polishing pad useful in chemical mechanical polishing having a polishing layer comprising a polymer matrix comprising the reaction product of an isocyanate terminated urethane prepolymer and a chlorine-free aromatic polyamine cure agent and chlorine-free microelements distributed within the polymer matrix having a specific gravity of 0.01 to 0.2, preferably 0.02-0.15, more preferably 0.05 to 0.1, yet more preferably 0.070-0.096.

Aspect 2: The polishing pad as in Aspect 1 wherein the microelements have a volume averaged particle size of 1 to 120, preferably 5-80, more preferably 15-40 and most preferably 15-30 micrometers.

Aspect 3. The polishing pad of Aspect 1 or 2 wherein the polishing layer has a chlorine content less than 0.1 wt % based on total weight of the polishing layer as determined by energy-dispersive X-ray spectroscopy or by Combustion Ion Chromatography (CIC) as set out in ASTM D7359-18.

Aspect 4. The polishing pad of Aspect 1 or 2 wherein the polishing pad has a chlorine content less than 0.1 wt % based on total weight of the polishing pad as determined by energy-dispersive X-ray spectroscopy or by Combustion Ion Chromatography (CIC) as set out in ASTM D7359-18.

Aspect 5: A polishing pad useful in chemical mechanical polishing having a polishing layer comprising a polymer matrix comprising the reaction product of an isocyanate terminated urethane prepolymer and a chlorine-free aromatic polyamine cure agent and chlorine-free microelements distributed within the polymer matrix wherein the polishing layer has a chlorine content less than 0.01 wt % based on total weight of the polishing layer as determined by Combustion Ion Chromatography (CIC) as set out in ASTM D7359-18.

Aspect 6: The polishing pad of any one of the previous Aspects wherein the cure agent is an aromatic diamine.

Aspect 7: The polishing pad of any one of the previous Aspects wherein the cure agent comprises a compound of the formula

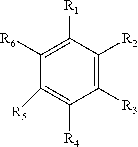

where R₁ and R₃ or R₁ and R₄ are amine groups (i.e. —NH₂) or alkyl amine groups having 1 to 5 carbon atoms, preferably amine groups, and R₂, R₅, R₆, and whichever of R₃ or R₄ is not an amine containing group are independently selected in each occurrence from H, -L-alkyl groups of 1-4, preferably 1-2, carbon atoms, where L is a direct bond, or a linking group, preferably O or S, most preferably S.

Aspect 8: The polishing pad of anyone of the preceding Aspects wherein the cure agent comprises diethyl toluene diamine (DETDA), dimethyl thio-toluene diamine (DMTDA), or a combination thereof.

Aspect 9: The polishing pad of any one of the previous Aspects wherein the microelements have a shell comprising an acrylonitrile copolymer.

Aspect 10: The polishing pad of any one of the previous Aspects wherein the polishing layer comprises the microelements in an amount of 5 to 50, preferably 10 to 45, more preferably 10 to 40, and most preferably 10 to 35 percent by volume based on total volume of the polishing layer.

Aspect 11: The polishing pad of any one of the previous Aspects wherein the microelement has a wall thickness of 30 to 300 nanometers, preferably 50 to 200 nanometers.

Aspect 12: A method comprising providing a substrate, providing the polishing pad of any one of Aspects 1-11, providing a slurry between the polishing pad and the substrate, polishing the substrate with the pad and slurry.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g. “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

What is claimed is:

1. A polishing pad useful in chemical mechanical polishing having a polishing layer comprising
a polymer matrix comprising the reaction product of an isocyanate terminated urethane prepolymer and a chlorine-free aromatic polyamine cure agent
and chlorine-free microelements having a specific gravity of 0.01 to 0.2 distributed within the polymer matrix.

2. The polishing pad of claim 1 wherein the polishing layer has a chlorine content less than 0.1 wt % based on total weight of the polishing layer as determined by energy-dispersive X-ray spectroscopy.

3. The polishing pad of claim 1 wherein the cure agent is an aromatic diamine.

4. The polishing pad of claim 1 wherein the aromatic diamine has the formula 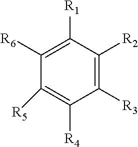
where either R₁ and R₃ or R₁ and R₄ are amine groups or alkyl amine groups having 1 to 5 carbon atoms and R₂, R₅, R₆, and whichever of R₃ or R₄ does not contain an amine containing group are independently selected in each occurrence from H, -L-alkyl groups of 1-4, carbon atoms, where L is a direct bond, or a linking group selected from O or S.

5. The polishing pad of claim 1 wherein the cure agent comprises diethyl toluene diamine (DETDA), dimethyl thio-toluene diamine (DMTDA), or a combination thereof.

6. The polishing pad of claim 1 wherein the microelements have a shell comprising an acrylonitrile copolymer.

7. The polishing pad of claim 1 wherein the polishing layer comprises the microelement in an amount of 5 to 50 percent by volume based on total volume of the polishing layer portion.

8. The polishing pad of claim 1 wherein the microelement has a volume averaged particle size of 1 to 120 micrometers.

9. The polishing pad of claim 1 wherein the microelement has a wall thickness of 30 to 300 nanometers.

10. A polishing pad useful in chemical mechanical polishing having a polishing layer comprising a polymer matrix comprising the reaction product of an isocyanate terminated urethane prepolymer and a chlorine-free aromatic polyamine cure agent and chlorine-free microelements distributed within the polymer matrix wherein the polishing layer has a chlorine content less than 0.01 wt % based on total weight of the polishing layer as determined by Combustion Ion Chromatography (CIC) as set out in ASTM D7359-18, wherein the chlorine-free microelements having a volume averaged particle size of 15 to 30 micrometers and an average shell wall thickness of 30 to 300 nanometers.
